(19) United States
(12) Patent Application Publication
(10) Pub. No.: US 2012/0124183 A1
(43) Pub. Date: May 17, 2012

(54) CLIENTS AND SERVERS FOR ALLOCATING AND MANAGING EXCLUSIVE ACCESS TO A PORTION OF REMOTE STORAGE SPACE

(76) Inventors: James Louis Long, Fort Collins, CO (US); Jacson D. Goldman, Fort Collins, CO (US); Bernd Sitzmann, Fort Collins, CO (US)

(21) Appl. No.: 13/386,662

(22) PCT Filed: Mar. 31, 2010
(86) PCT No.: PCT/US2010/029349

§ 371 Date: Jan. 23, 2012

(51) Int. Cl. G06F 15/16

(52) U.S. Cl. 709/219

(57) ABSTRACT

Example embodiments relate to a server for providing remote storage space to users. The server may include a mechanism that allocates a portion of storage space in the storage area in response to a request from a first remote user. The server may also include a mechanism that maintains storage records, the storage records identifying a user currently granted exclusive access to the portion of storage space. Furthermore, the server may include a mechanism that processes access requests to determine whether a remote user requesting access to the portion of storage space is the user currently granted exclusive access. Related clients, methods, and machine-readable storage media are also disclosed.

### BACKGROUND

With computing technology now cheaper and more accessible than ever before, digital data is playing an increasingly important role in the lives of billions of people. A typical user of a computing device may rely on digital documents for business, digital music and movies for entertainment, and digital photos for capturing life events. As the average size of these files and user reliance on digital storage have increased, the amount of storage space required for user data has similarly increased.

In order to store such large amounts of data, many users rely on remote storage, such that the user writes his or her data to a remote server that contains a pool of available storage space. In this manner, storage may be provided to users as a commodity, thereby limiting the amount of local storage required on each user's device. For example, such a storage arrangement is common in many businesses, where each employee is generally expected to store his or her data on a shared server. Many home users also rely on remote storage to back up critical data or store particularly large files.

Sharing of this remote data between users is an important element of a successful networking model. Problematically, in a typical server environment with networked file sharing, the first user who accesses a particular file retains control of that file until he or she closes it. Such a model leads to competition for access and user frustration when, for example, a user requires immediate access to the file. On the other hand, systems that allow for concurrent write access are often too complex, resulting in user confusion in configuring and using the system. Ultimately, existing server-based storage systems fail to provide an effective sharing model that is easy to understand and utilize.

### BRIEF DESCRIPTION OF THE DRAWINGS

In the accompanying drawings, like numerals refer to like components or blocks. The following detailed description references the drawings, wherein:

FIG. 1 is a block diagram of an example server for providing remote storage space to users;

FIG. 2 is a block diagram of an example client computing device for accessing and managing storage space maintained on a remote server;

FIG. 3 is a block diagram of an example client-server architecture for providing and managing remote storage space;

FIG. 4A is a flowchart of an example method performed by a client computing device to request allocation of remote storage space;

FIG. 4B is a flowchart of an example method performed by a server to allocate remote storage space;

FIG. 5A is a flowchart of an example method performed by a client computing device to request a transfer of exclusive access to remote storage space to another user;

FIG. 5B is a flowchart of an example method performed by a server to transfer exclusive access to remote storage space to another user;

FIG. 6A is a flowchart of an example method performed by a client computing device to regain exclusive access to remote storage space;

FIG. 6B is a flowchart of an example method performed by a server to restore exclusive access to remote storage space to a client computing device;

FIG. 7A is a block diagram of an example operation flow for requesting and allocating remote storage space;

FIG. 7B is a block diagram of an example operation flow for transferring exclusive access to remote storage space;

FIG. 7C is a block diagram of an example operation flow for accessing remote storage space; and

FIG. 7D is a block diagram of an example operation flow for regaining exclusive access to remote storage space.

### DETAILED DESCRIPTION

As detailed above, existing server-based storage systems fail to provide for effective yet user-friendly sharing of data. Thus, as described below, various embodiments allow for provisioning of and access to storage space on a remote server using an easily-understood sharing model. From the perspective of a user, this storage model is familiar, as it maps to a real-world model—physically maintaining or transferring possession of a portable storage device, such as a flash memory drive.

In particular, in some embodiments, a server allocates a portion of storage space in response to a request from a user, maintains storage records identifying a user currently granted exclusive access to the portion of storage space, and processes access requests to determine whether they originated from the user with exclusive access. Furthermore, in some embodiments, a user may request allocation of a portion of remote storage space, write to that storage space, and, when desired, transfer exclusive rights for accessing the space to another user. In addition, in some embodiments, the user may specify a subset of rights to be transferred and, when he or she again requires access, send a request or demand to the server to regain access rights from the other user. Additional embodiments and applications of such embodiments will be apparent to those of skill in the art upon reading and understanding the following description.

In the description that follows, reference is made to the term, “machine-readable storage medium.” As used herein, the term “machine-readable storage medium” refers to any electronic, magnetic, optical, or other physical storage device that contains or stores executable instructions or other data (e.g., a hard disk drive, flash memory, etc.).

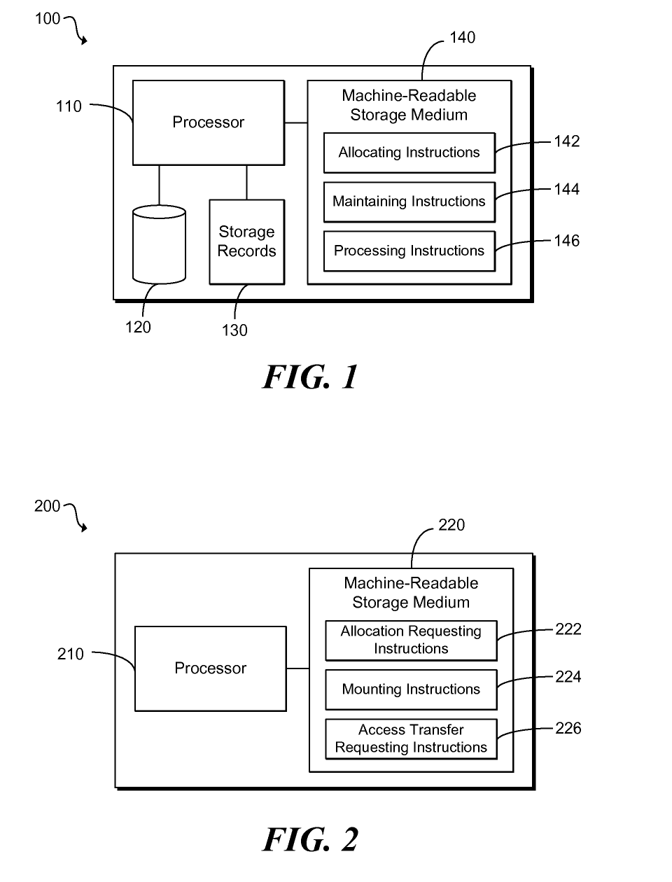

Referring now to the drawings, FIG. 1 is a block diagram of an example server 100 for providing remote storage space to users. Server 100 may be, for example, an enterprise server of a local area network, a cloud computing server, a home media server, or the like. In the embodiment of FIG. 1, server 100 includes a processor 110, a storage area 120, storage records 130, and a machine-readable storage medium 140.

Processor 110 may be a central processing unit (CPU), a semiconductor-based microprocessor, or any other hardware device suitable for retrieval and execution of instructions stored in machine-readable storage medium 140. In particular, processor 110 may fetch, decode, and execute allocating instructions 142, maintaining instructions 144, and processing instructions 146.

Storage area 120 may comprise a number of physical media for storing data under the direction of processor 110. For example, storage area 120 may include one or more hard disks, solid state drives, tape drives, nanodrives, holographic storage devices, or any combination of such storage devices. In some embodiments, storage area 120 may include a plurality of storage devices that, in combination, form a pool of available storage. Thus, as an example, storage area may be a Redundant Array of Inexpensive Disks (RAID) or, alternatively, a spanning set of disks (also known as “Just a Bunch of Disks” (JBOD)). Other suitable configurations for providing storage space in storage area 120 will be apparent to those of skill in the art. In some embodiments, storage area 120 may protect user data through the use of disk redundancy and server backups implemented using techniques that will be apparent to those of skill in the art.

Storage records 130 may comprise a set of information identifying each allocated portion of storage area 120 and describing characteristics of each portion. For example, storage records 130 may identify, for each allocated portion, the total amount of storage space available to the user, the amount of storage space used, the owner of the storage space, the user currently granted exclusive access, and/or access rights granted to the current user with exclusive access. Storage records 130 may be maintained as a database, a configuration file or set of files, or in any similar arrangement and may be stored in storage area 120 or, alternatively, in a dedicated storage area.

Machine-readable storage medium 140 may be an electronic, magnetic, optical, or other physical device that contains or stores executable instructions. In particular, processor 110 may execute instructions 142, 144, 146 stored in machine-readable storage medium 140 to implement the functionality described in detail herein.

Machine-readable storage medium 140 may include allocating instructions 142 that allocate a portion of storage space in storage area 120 in response to a request from a user of a client, such as client computing device 200 of FIG. 2. The portion of storage space may be, for example, a folder created for the user in storage area 120 of server 100, such that the user may access the shared folder location on server 100. Alternatively, the portion of storage space may be a disk partition, a range of addresses on a storage device, or even an entire physical storage device. Other suitable variations of the portion of storage space will be apparent to those of skill in the art.

A request from a user may identify the user and, in some embodiments, a total amount of storage space desired by the user. The identity of the user may be determined, for example, based on a user name of the user, an Internet Protocol (IP) address of the client computing device, or based on the client computing device's identity within a domain or workgroup managed by server 100. Prior to allocation of storage space, server 100 may, in some embodiments, determine whether the user is in a list of users allowed to access the service. For example, such a list may contain users who have paid or otherwise registered for the service, users who were identified by a system administrator, or users who are otherwise permitted access. If included in the request, the amount of storage space desired by the user may be expressed as a number of megabytes, gigabytes, or any other unit for measuring the size of digital information.

In response to receipt of a request, allocating instructions 142 may determine an amount of storage available in storage area 120 and only allocate space if it is available. Alternatively, allocating instructions 142 may use a dynamic allocation process, such that the amount of storage space allocated to users may exceed the total amount of actual space available in storage area 120. In such embodiments, storage area 120 may store user data as it is received until reaching a maximum capacity.

Machine-readable storage medium 140 may further include maintaining instructions 144 that maintain storage records 130 that reflect the current status of each allocated portion of storage space. For example, maintaining instructions 144 may update storage records 130 upon allocation of space to reflect an identifier for the space, the total amount of space allocated, the amount of space used, the user who owns the space, the user currently granted exclusive access, and/or the access rights granted to the current user. Maintaining instructions 144 may also maintain an identifier of the location of the user's data in storage area 120 (e.g., a folder name and path, a volume identifier, a logical unit number, etc.), authentication data (e.g., passwords) used to access the storage, and any other data used to implement the remote storage of data.

In addition, machine-readable storage medium 140 may include processing instructions 146 that process access requests received from users. Upon receipt of an access request, such as a read or write request, processing instructions 146 may, for example, determine the identity of the user, determine which portion of storage space the user is attempting to access, and then determine whether the user is authorized to access that space. For example, processing instructions 146 may query storage records 130 to determine whether the requesting user is currently granted exclusive access to the identified portion of storage space and whether the access request is within the rights granted to the user. In addition, for write requests, processing instructions 146 may determine whether sufficient storage space remains in the allocated portion to allow the write to proceed. If it is determined that the user is authorized to carry out the particular operation, processing instructions 146 may then read the requested data from storage area 120 or write the included data to the portion of storage space in storage area 120, then return the data or a write confirmation to the requesting client.

FIG. 2 is a block diagram of an example client computing device 200 for accessing and managing storage space maintained on a remote server, such as server 100 of FIG. 1. Computing device 200 may be, for example, a desktop computer, a laptop computer, a handheld computing device, a mobile phone, or the like. In the embodiment of FIG. 2, computing device 200 includes a processor 210 and a machine-readable storage medium 220.

Processor 210 may be a central processing unit (CPU), a semiconductor-based microprocessor, or any other hardware device suitable for retrieval and execution of instructions stored in machine-readable storage medium 220. In particular, processor 210 may fetch, decode, and execute instructions 222, 224, 226 to implement the functionality described in detail below.

Machine-readable storage medium 220 may be encoded with executable instructions for requesting, accessing, and managing remote storage space on a server. These executable instructions may be, for example, a portion of an operating system (OS) of computing device 100 or a separate client application running on top of the OS. As another example, the executable instructions may be included in a web browser, such that the web browser implements the interface described in detail herein. Other suitable formats of the executable instructions will be apparent to those of skill in the art.

Machine-readable storage medium 220 may include allocation requesting instructions 222 that receive and submit a request for storage space to a remote server. Allocation requesting instructions 222 may first receive an indication from the user that the user desires remote storage space and, in some embodiments, a specification of the amount of storage space desired. The user may submit this request, for example, by interacting with a user interface of computing device 200. Upon receipt of the request from the user, allocation requesting instructions 222 may then prepare a message for transmission to the remote server. The message may include, for example, an identity of the user and an amount of storage space desired. Allocating requesting instructions 222 may then transmit the request to the remote server using, for example, a known IP or Media Access Control (MAC) address of the server. The server to which the request is sent may be selected, for example, using a server discovery process, a manual specification of server locations, or a preconfigured server location coded into allocating requesting instructions 222.

Machine-readable storage medium 220 may also include mounting instructions 224, which may mount a local drive corresponding to the remote portion of storage space upon determining that the space was allocated. In particular, upon allocating the space, the remote server may send a message to client computing device 220 confirming that the allocation was successful. In response, mounting instructions 224 may map a network drive that appears to be a local drive to the user. In particular, mounting instructions 224 may configure the drive such that, upon accessing the local drive, computing device 200 may automatically establish a connection with the remote server to allow access to the contents of the portion of storage space. For example, when the portion of remote storage space is a folder created in the storage area of the remote server, computing device 200 may create a shortcut to the remote location of the folder and map that shortcut to an available drive letter.

In this manner, the user of computing device 200 may access the remote drive as if it were a flash memory drive plugged into the device. Thus, the user may add, remove, and edit files, add directories, format the entire space, or perform any other access operations. For example, in a Microsoft Windows-based system, the portion of remote storage space may be accessible as drive “X:” from the “My Computer” window or on the user's desktop. Other suitable mounting implementations will be apparent to those of skill in the art depending on the operating system used on computing device 200.

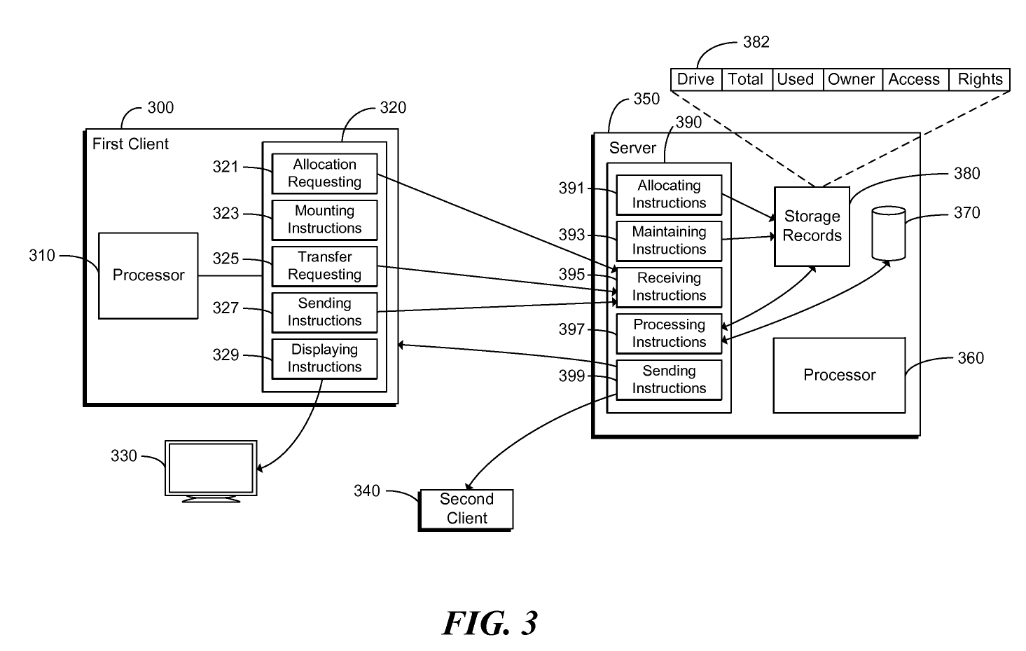

Finally, machine-readable storage medium 220 may include access transfer requesting instructions 226, which may allow a user to request a transfer of exclusive access to another user by transmitting a request to the server. In particular, such a request may identify the portion of storage space and a user to whom exclusive access will be transferred. In some embodiments, the request may also include a specification of access rights to be granted to the other user (e.g., read-only, read-write, read-write-delete, etc.). A user may submit the request by, for example, accessing an option in a right-click menu for the mounted drive or selecting an option from the client application. In response to receipt of the transfer request, the remote server may update its storage records to reflect the change, as described in further detail below in connection with FIG. 3.

In this manner, a user may quickly and easily transfer access rights to the entire portion of storage space, similar to a user physically transferring possession of a flash memory drive. Advantageously, the user may thereby manage the transfer of access rights at the drive-level, rather than at a file or folder level of granularity.

FIG. 3 is a block diagram of an example client-server architecture for providing and managing remote storage space. As illustrated, the client-server architecture may include a first client computing device 300, a second client computing device 340, and a server 350.

First client computing device 300 may include a processor 310, a machine-readable storage medium 320, and a display device 330. As with processor 210 of FIG. 2, processor 310 may be a central processing unit (CPU), a semiconductor-based microprocessor, or any other hardware device suitable for retrieval and execution of instructions stored in machine-readable storage medium 320. Machine-readable storage medium 320 may be encoded with executable instructions 321, 323, 325, 327, 329 for requesting, accessing, and managing remote storage space on server 350.

Allocation requesting instructions 321 may request allocation of a portion of storage space on remote server 350, as described in detail above in connection with allocation requesting instructions 222 of FIG. 2. In particular, allocation requesting instructions 321 may send a request for storage space to server 350 for receipt by receiving instructions 395, which are described in further detail below.

Mounting instructions 323 may mount a local drive corresponding to the remote portion of storage space, as described in detail above in connection with mounting instructions 224 of FIG. 2. In particular, mounting instructions 323 may receive a confirmation message from server 350 that space has been allocated and, upon receipt of this message, establish a local drive for access by the user.

Transfer requesting instructions 325 may send a request to transfer exclusive access to another user, such as a user of second client computing device 340, by transmitting a request to remote server 350. In particular, transfer requesting instructions 325 may send a transfer request to server 350 for receipt by receiving instructions 395, which are described in further detail below.

Sending instructions 327 may send a message to restore exclusive access to the remote storage space to the user of first client computing device 300. For example, after transferring exclusive access to a user of second client computing device 340, the user of first client 300 may determine that he or she wishes to regain access to the portion of storage space. Accordingly, the owner of the portion of storage space (e.g., the person who originally requested the space) may utilize sending instructions 327 to send either a request or demand to server 350, indicating that the user wishes to regain exclusive access to the storage space. A request may be subject to approval by the current user with exclusive access via a query sent by server 350. In contrast, a demand may automatically regain access from the current user and restore it to the owner of the storage space. In this manner, a user may restore use of the storage space in a manner analogous to regaining physical possession of a flash memory drive from a user who borrowed the drive.

Displaying instructions 329 may be used to output information regarding the portion of storage space to the user of first client computing device 300. In some embodiments, displaying instructions 329 may be executed to indicate to the user whether he or she currently has exclusive access to a portion of remote storage space. For example, displaying instructions 329 may output a first indication when the user has exclusive access and a second indication different than the first when the user has transferred exclusive access to another user, such as a user of second computing device 340. These indications may be, for example, icons that are visually different. As a more specific example, the first icon may be a solid icon representing a flash memory drive or similar device, while the second icon may be transparent. In this manner, a user may determine whether he or she currently has exclusive access to a portion of remote storage space by examining the icon.

Output device 330 may be a display device, such as a cathode ray tube (CRT) monitor, a liquid crystal display (LCD) screen, or a screen implemented using another display technology. Output device 330 may be internal or external to first client computing device 300 depending on the configuration of first client computing device 300.

Second client computing device 340 may be configured similarly to first client computing device 300. Thus, second client computing device 340 may include a processor and a machine-readable storage medium encoded with executable instructions with functions corresponding to those of instructions 321, 323, 325, 327, 329. In this manner, a user of second computing device 340 may request storage space on server 350 or access storage space transferred to him or her by a user of first client 300.

Server 350 may include a processor 360, a storage area 370, storage records 380, and a machine-readable storage medium 390. As with processor 110 of FIG. 1, processor 360 may be a central processing unit (CPU), a semiconductor-based microprocessor, or any other hardware device suitable for retrieval and execution of instructions stored in machine-readable storage medium 390. Similarly, storage area 370 may comprise a number of physical media for storing data, as described in detail above in connection with storage area 120 of FIG. 1.

Storage records 380 may comprise a set of information describing the allocated portions of storage area 370, as described in detail above in connection with storage records 130 of FIG. 1. In particular, as illustrated in FIG. 3, storage records 380 may include a plurality of fields 382, including an identifier of each portion or “drive,” a total amount of space in the portion, an occupied or used amount of space in the portion, a user who “owns” the space, a user currently granted exclusive access, and the access rights of the user currently granted exclusive access.

Machine-readable storage medium 390 may be encoded with executable instructions 391, 393, 395, 397, 399 for allocating, accessing, and managing storage space in storage area 370 and storage records 380. Allocating instructions 391 may allocate a portion of storage space in storage area 370 in response to receipt of a request from a user, such as a user of first client computing device 300 or second client computing device 340. The portion of storage space may be, for example, a folder or directory in storage space 370, a partition or subset of a partition, an entire physical drive, or any other unit of storage space. Further details are provided above in connection with allocating instructions 142 of FIG. 1.

Maintaining instructions 393 may maintain storage records 380 based on allocation, access, and transfer requests received from users of clients 300, 340. In particular, maintaining instructions 393 may, upon allocation of a portion of storage space in storage area 370, create a record in storage records 380 indicating an identity of the drive, a total amount of storage space allocated, an amount of space used, the owner of the space, a user currently granted exclusive access, and access rights granted to the user with exclusive access. In addition, upon receipt of a request to transfer exclusive access by receiving instructions 395, maintaining instructions 393 may update storage records 380 to identify the new user with exclusive access to the storage space and to reflect the access rights to be granted to that user. Maintaining instructions 393 may similarly update storage records 380 to indicate that the owner has exclusive access upon initialization of the space and after successful execution of a request or demand to regain exclusive access.

Receiving instructions 395 may receive communications from one or more clients 300, 340 used to allocate, access, and transfer space in storage area 370. In particular, receiving instructions 395 may receive a request for allocation of storage space and trigger execution of allocating instructions 391 and maintaining instructions 393 based on the received request. In addition, receiving instructions 395 may receive access requests (e.g., read, write) and forward the received requests to processing instructions 397 for processing.

Receiving instructions 395 may also receive a request to transfer exclusive access from an owner of a portion of storage space and, in response, trigger execution of maintaining instructions 393 to update storage records 380 and execution of sending instructions 399 to notify the affected client of the change in access. In some embodiments, receiving instructions 395 may receive, along with the transfer request, a specification of access rights to be provided to the second user (e.g., read, read-write, read-write-delete, etc.). Receiving instructions 395 may also receive demands or requests to regain exclusive access from an owner of storage space and, in response, trigger execution of maintaining instructions 393 to update storage records 380 and execution of sending instructions 399 to notify the affected client.

Processing instructions 397 may be configured to process access requests received from users, such as requests to read or write data to the portion of storage space. Upon receipt of an access request, processing instructions 397 may first determine whether the requesting user is the user currently granted exclusive access using storage records 380. If the requesting user is the user currently granted exclusive access, processing instructions 397 may then determine whether the particular access is within the user's rights, as specified by the owner of the portion of storage space. For example, processing instructions 397 may again access storage records 380 to determine which rights are granted to the user (e.g., read, write, delete, etc.), then determine whether the particular request is permitted.

Sending instructions 399 may be configured to send communications to clients in a number of circumstances. For example, sending instructions 399 may send a notification to a client, such as second client 340, when the client 340 has been granted exclusive access to a portion of storage space. Similarly, sending instructions 399 may send a request to a client, such as second client 340, when an owner of a portion of storage space has requested restoration of exclusive access. In response, a user of the receiving client may indicate whether he or she is willing to return exclusive access to the owner of the portion of storage space 370. Sending instructions 399 may also send a notification to the client when the owner has reclaimed exclusive access through the use of a demand, rather than a request.

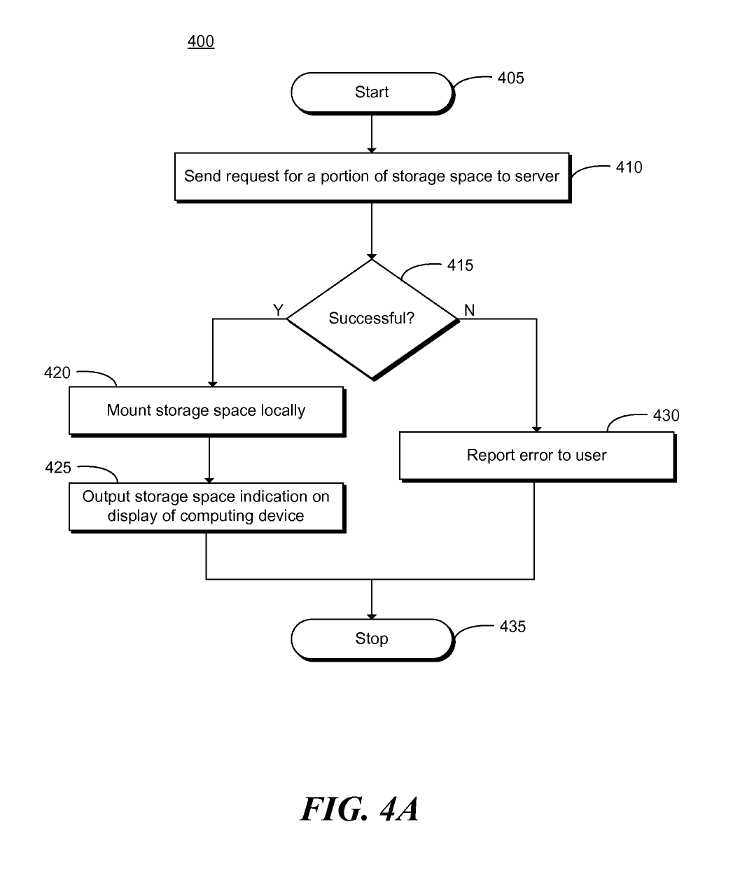

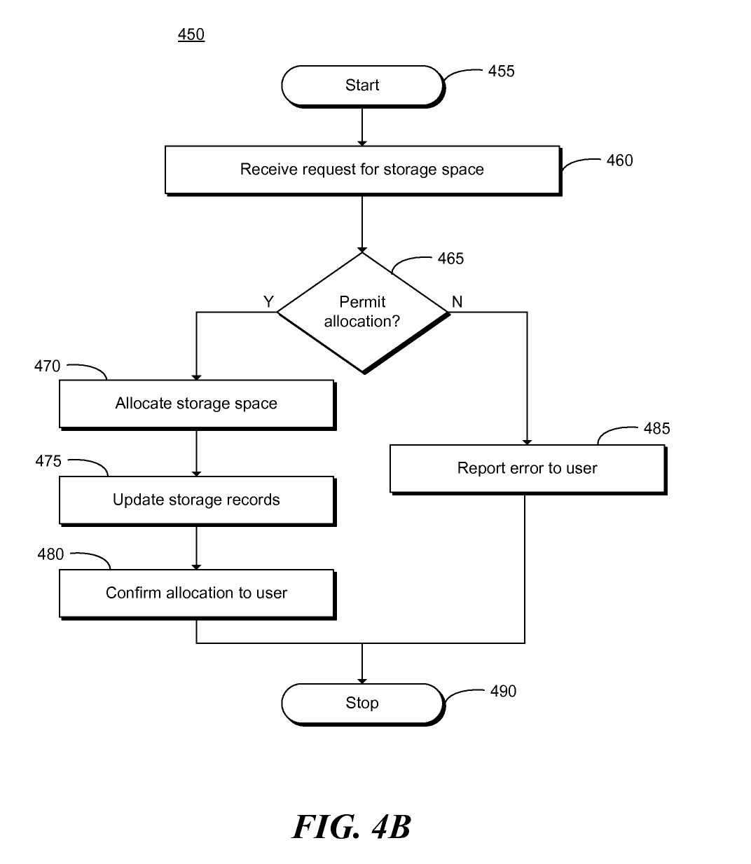

FIG. 4A is a flowchart of an example method 400 performed by a client computing device 300 to request allocation of remote storage space. Although execution of method 400 is described below with reference to the components of client computing device 300, other suitable components for execution of method 400 will be apparent to those of skill in the art. Method 400 may be implemented in the form of executable instructions stored on a machine-readable storage medium, such as machine-readable storage medium 320 of FIG. 3.

Method 400 may start in block 405 and proceed to block 410, where client computing device 300 may send a request for a portion of storage space to a remote server 350. This request may include, for example, an indication that the user desires remote storage space and, in some embodiments, an amount of storage space desired for allocation. For example, a user might indicate that he or she wishes to obtain 1 gigabyte of remote storage on server 350.

Method 400 may then proceed to block 415, where client computing device 300 may receive a response from remote server 350 regarding the allocation. In particular, the response may indicate whether the allocation was successful and, if so, one or more parameters that may be used to access the allocated portion of storage space (e.g., a folder location, a drive letter, etc.). Alternatively, if the allocation was not successful, the response from remote server 350 may include one or more reasons that the allocation was unsuccessful (e.g., the user is not authorized to access the service, the user has exceeded a maximum of amount allocated space or number of portions, the user must first pay for access, etc.).

When it is determined in block 415 that the allocation was successful, method 400 may proceed to block 420, where client computing device 300 may locally mount the storage space. For example, client computing device 300 may configure a local drive such that the user may automatically establish a connection with remote server 350 upon accessing the drive. Method 400 may then proceed to block 425, where client computing device 300 may display an indication of the mounted storage space on output device 330. For example, client computing device 300 may output an icon or other representation of a flash memory drive or other storage device. Method 400 may then proceed to block 435, where method 400 may stop.

Alternatively, when it is determined in block 415 that the allocation of space was not successful, method 400 may proceed to block 430, where client computing device 300 may report the error to the requesting user. For example, client computing device 300 may display the reasons that the allocation was unsuccessful on output device 330. Method 400 may then proceed to block 435, where method 400 may stop.

FIG. 4B is a flowchart of an example method 450 performed by a server 350 to allocate remote storage space. Although execution of method 450 is described below with reference to the components of server 350, other suitable components for execution of method 450 will be apparent to those of skill in the art. Method 450 may be implemented in the form of executable instructions stored on a machine-readable storage medium, such as machine-readable storage medium 390 of FIG. 3.

Method 450 may start in block 455 and proceed to block 460, where server 350 may receive a request for allocation of a portion of storage space from a client computing device, such as first client computing device 300. This request may identify the user and, in some embodiments, an amount of storage space desired for allocation.

Method 450 may then proceed to block 465, where server 350 may determine whether to permit allocation of the requested storage space. Server 350 may first identify the user, then determine whether the user is authorized to access the storage service. For example, server 350 may access a list of users who have paid or registered for the service, who are approved for access by a network administrator, or who are otherwise permitted to request storage space. Server 350 may then determine whether the requested amount of storage is available for allocation to the user considering, for example, the amount of storage remaining in storage area 370 and a per-user limit on requested space.

When it is determined in block 465 that allocation of the requested space is permitted, method 450 may proceed to block 470, where server 350 may allocate the storage space using dynamic allocation or by reserving the entire amount of requested space. Method 450 may then proceed to block 475, where server 350 may update storage records 380 to reflect that the space has been allocated. For example, server 350 may add an entry to storage records 380 containing information for each of the fields 382. In some embodiments, server 350 may initialize storage records 380 to indicate that the requesting user is the user currently granted exclusive access to the storage space and that the requesting user has permission for all accesses. Finally, method 450 may proceed to block 480, where server 350 may transmit a confirmation of the allocation to the requesting user, including, for example, an identifier of the portion of storage space, a link to the storage space, or some other descriptor that uniquely identifies the portion of space. Method 450 may then proceed to block 490, where method 450 may stop.

Alternatively, when it is determined in block 465 that allocation of the requested space is not permitted, method 450 may proceed to block 485, where server 350 may send a notification to the user that allocation of the requested space is not permitted or was otherwise unsuccessful. In this notification, server 350 may include one or more reasons the allocation was not successful (e.g., insufficient space in storage area 370, the user is not authorized to request storage space, etc.). Method 450 may then proceed to block 490, where method 450 may stop.

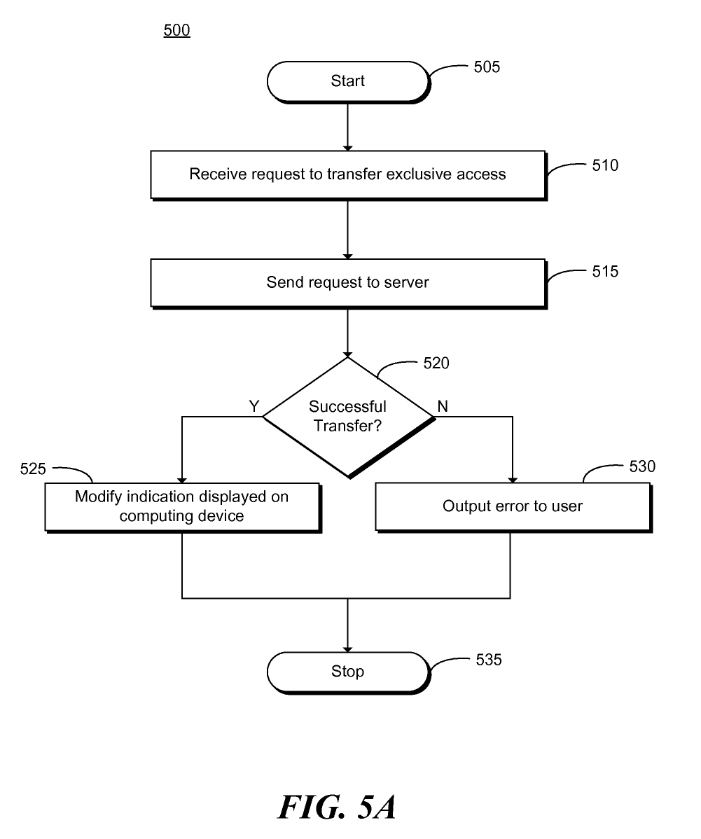

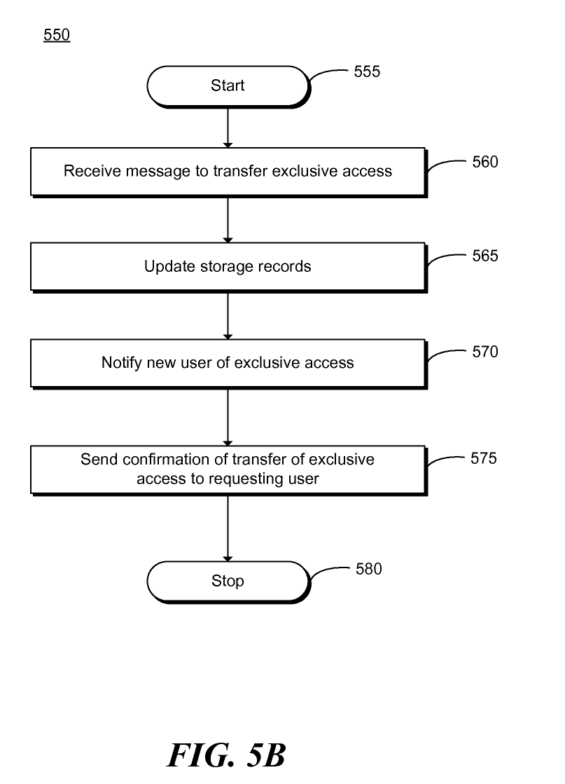

FIG. 5A is a flowchart of an example method 500 performed by a client computing device 300 to request a transfer of exclusive access to remote storage space to another user. Although execution of method 500 is described below with reference to the components of client computing device 300, other suitable components for execution of method 500 will be apparent to those of skill in the art. Method 500 may be implemented in the form of executable instructions stored on a machine-readable storage medium, such as machine-readable storage medium 320 of FIG. 3.

Method 500 may start in block 505 and proceed to block 510, where client computing device 300 may receive a request from a user to transfer exclusive access to a portion of storage space to another user. For example, the user may submit a request to transfer access by interacting with a client application used to access and manage the remote storage space, from an OS right-click shell menu, or using some other user interface. The user of client computing device 300 may identify the user that will receive exclusive access using, for example, a user name, an IP address, a name of the client computing device used by the other user, or another identifier. In addition, the user may identify the access rights to be granted to the other user (e.g., read-only, read-write, read-write-delete, etc.). Method 500 may then proceed to block 515, where client computing device 300 may submit the request to a remote server 350.

In block 520, upon receipt of a response from the server 350, client computing device 300 may determine whether the transfer of exclusive access was successful. When it is determined that the transfer of exclusive access was successful, method 500 may proceed to block 525, where computing device 300 may modify the indication displayed to the user for the portion of storage space. For example, computing device 300 may modify the visual features of an icon or other representation to indicate that the user of computing device 300 no longer has exclusive access to the portion of storage space. As described in detail above, such a modification may be a change in transparency or color, display of a different icon or text, or the like. In some embodiments, computing device 300 may also unmount the drive, such that it is no longer accessible to the user. Method 500 may then proceed to block 535, where method 500 may stop.

In contrast, when it is determined in block 520 that the transfer of exclusive access was not successful, method 500 may proceed to block 530. In block 530, computing device 300 may output a reason for the failed transfer of exclusive access. Method 500 may then proceed to block 535, where method 500 may stop.

FIG. 5B is a flowchart of an example method 550 performed by a server 350 to transfer exclusive access to remote storage space to another user. Although execution of method 550 is described below with reference to the components of server 350, other suitable components for execution of method 550 will be apparent to those of skill in the art. Method 550 may be implemented in the form of executable instructions stored on a machine-readable storage medium, such as machine-readable storage medium 390 of FIG. 3.

Method 550 may start in block 555 and proceed to block 560, where server 350 may receive a message requesting a transfer of exclusive access to a portion of storage space from one user to another. The request may identify, for example, the owner of the portion of storage space, a location or identifier of the portion, a user to whom exclusive access is to be transferred, and access rights to be granted to the new user.

After receipt of the request, method 550 may then proceed to block 565, where server 350 may update storage records 380 to reflect the transfer of exclusive ownership. In particular, server 350 may modify the storage record for the particular portion of storage space to reflect the identity of the user to be granted exclusive access and the access rights to be granted to that user. Method 550 may then proceed to block 570, where server 350 may notify the new user that he or she has been granted exclusive access to the portion of storage space. After notifying the new user, method 550 may then proceed to block 575, where server 350 may notify the owner of the portion of storage space that the transfer was successful or, alternatively, notify the owner of one or more reasons the transfer failed. Method 550 may then proceed to block 580, where method 550 may stop.

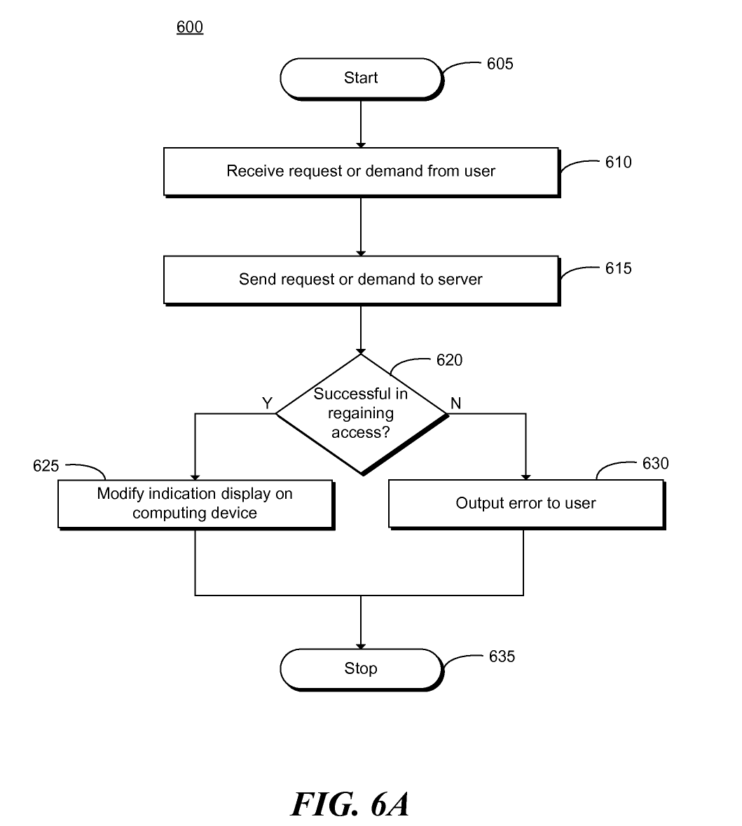

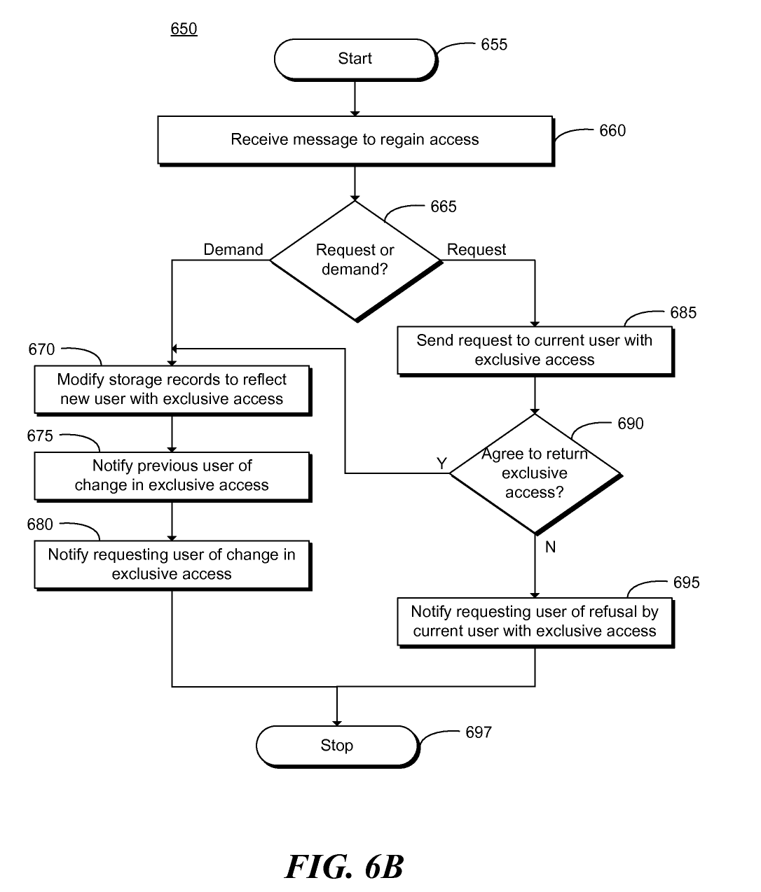

FIG. 6A is a flowchart of an example method 600 performed by a client computing device 300 to regain exclusive access to remote storage space. Although execution of method 600 is described below with reference to the components of client computing device 300, other suitable components for execution of method 600 will be apparent to those of skill in the art. Method 600 may be implemented in the form of executable instructions stored on a machine-readable storage medium, such as machine-readable storage medium 320 of FIG. 3.

Method 600 may start in block 605 and proceed to block 610, where client computing device 300 may receive a request or demand to regain exclusive access from a user. In particular, the user may identify the particular portion of storage space and indicate whether he or she would like to request return of exclusive access from the current user or, alternatively, automatically regain access without the current user's approval. After receipt of the request or demand from the user, method 600 may proceed to block 615, where computing device 300 may transmit the request or demand to a remote server, such as server 350.

In block 620, upon receipt of a response from server 350, client computing device 300 may determine whether the user has successfully regained exclusive access to the portion of remote storage space. When it is determined that the user has successfully regained exclusive access to the portion of storage space, method 600 may proceed to block 625, where computing device 300 may modify the indication displayed to the user to represent the portion of storage space. For example, computing device 300 may modify the visual features of an icon or other representation to indicate that the user of computing device 300 now has exclusive access to the portion of storage space. As described above, such a modification may be a change in transparency or color, display of a different icon or text, or the like. Method 600 may then proceed to block 635, where method 600 may stop.

In contrast, when it is determined in block 620 that the user was unsuccessful in regaining exclusive access from the other user, method 600 may proceed to block 630. In block 630, computing device 300 may output a reason for the failed attempt to regain exclusive access. For example, when the user requested rather than demanded exclusive access, the transfer of access may be unsuccessful when the other user refuses to return access to the owner of the portion of storage space. After outputting any relevant errors to the user, method 600 may proceed to block 635, where method 600 may stop.

FIG. 6B is a flowchart of an example method 650 performed by a server 350 to restore exclusive access to remote storage space to a client computing device. Although execution of method 650 is described below with reference to the components of server 350, other suitable components for execution of method 650 will be apparent to those of skill in the art. Method 650 may be implemented in the form of executable instructions stored on a machine-readable storage medium, such as machine-readable storage medium 390 of FIG. 3.

Method 650 may start in block 655 and proceed to block 660, where server 350 may receive a message requesting or demanding that exclusive access to a portion of storage space be returned to the user. The request or demand may identify, for example, the owner of the portion of storage space, a location or identifier of the portion, and a user from whom exclusive access is to be regained.

After receipt of the request or demand, method 650 may proceed to block 665, where server 350 may determine whether the received message is a demand or a request. When it is determined that the message is a demand to regain exclusive access, method 650 may proceed to block 670, where server 350 may modify storage records 380 to indicate that the owner is now the user with exclusive access. In some embodiments, because the owner now has exclusive access, server 350 may reset the access rights in storage records 380 to indicate that the user has permission for all access operations.

After modifying the storage records, method 650 may proceed to block 675, where server 350 may notify the previous user of the change in exclusive access. For example, server 350 may send a notification indicating that the owner of the portion of storage space has taken back exclusive access. Alternatively, in some embodiments, server 350 may first send a warning to the previous user that access rights will be taken away in a predetermined period of time (e.g., 1 minute) and indicate that the user should close all files or risk data loss. Method 650 may then proceed to block 680, where server 350 may notify the requesting user (i.e., the owner) that the change in exclusive access was successful. Method 650 may then proceed to block 697, where method 650 may stop.

Alternatively, when it is determined in block 665 that the message was a request to regain exclusive access, method 650 may proceed to block 685. In block 685, server 350 may prepare and send a request to the current user with exclusive access, asking whether the user agrees to return exclusive access to the owner of the portion of storage space. Method 650 may then proceed to block 690, where server 350 may await a response from the user. When it is determined in block 690 that the user has agreed to return exclusive access to the owner, method 650 may proceed to blocks 670, 675, and 680, described in detail above. Alternatively, when it is determined that the current user has refused to return exclusive access to the owner, method 650 may proceed to block 695, where server 350 may notify the owner of the refusal. Method 650 may then proceed to block 697, where method 650 may stop.

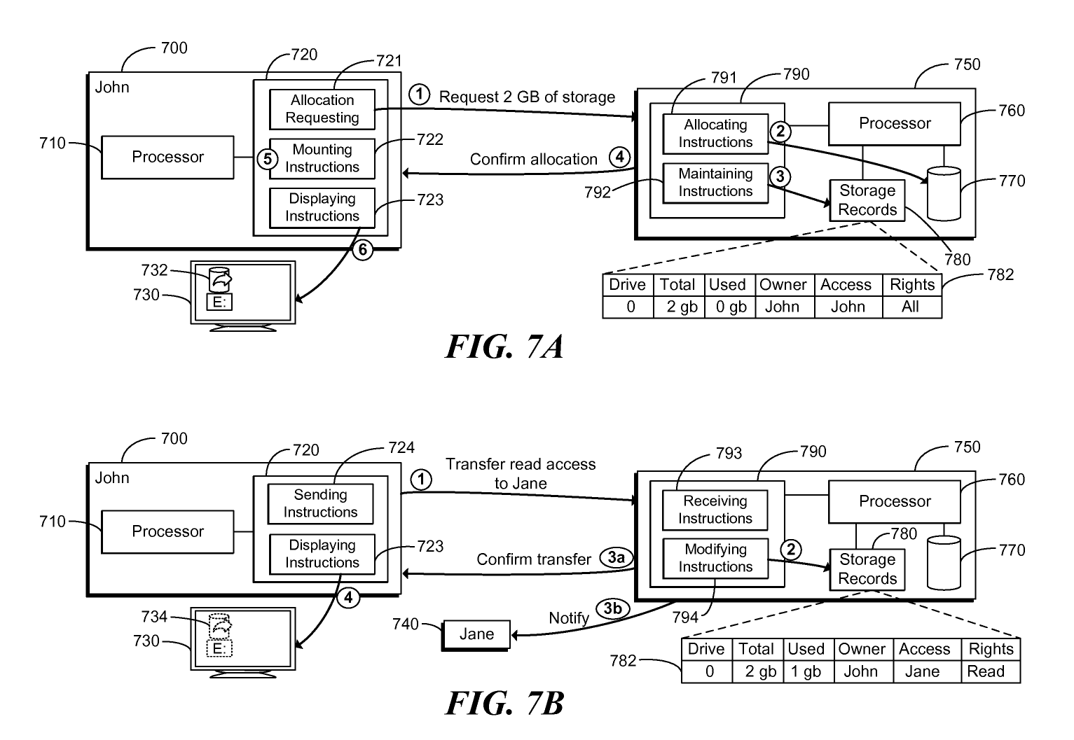

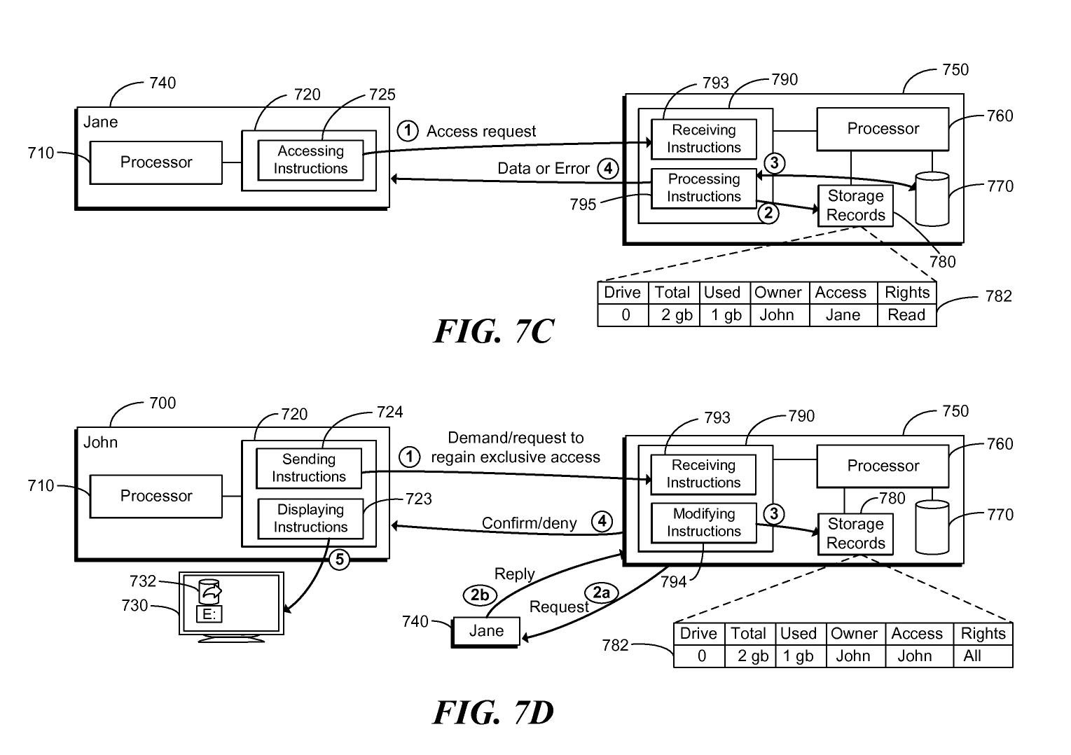

FIG. 7A is a block diagram of an example operation flow for requesting and allocating remote storage space. As illustrated, a client computing device 700 operated by John includes a processor 710, a machine-readable storage medium 720, and an output device 730. John's computing device 700 is in communication with a server 750 including a processor 760, a storage area 770, storage records 780, and a machine-readable storage medium 790. Each of the components in client computing device 700 and server 750 may be configured similarly to the corresponding components discussed in detail above in connection with FIGS. 1-3.

As illustrated, in block 1 of the operation flow, John may submit a request to client computing device 700 to obtain 2 gigabytes (GB) of remote storage. In response, allocation requesting instructions 721 may prepare a request for 2 GB of storage and transmit the request to server 750. In response, in block 2 of the operation flow, allocating instructions 791 of server 750 may determine whether the request should be fulfilled by, for example, determining whether John is authorized to use the service and determining the amount of storage remaining in storage area 770.

When it is determined that John is authorized to use the service and that sufficient storage space is available, maintaining instructions 792 may update storage records 780 in block 3 of the operation flow. In particular, maintaining instructions 792 may create an entry 782 in storage records 780 indicating that Drive 0 with a total of 2 GB of storage space is owned by John. Entry 782 may also indicate that John has used 0 GB of the available storage, that John is the current owner, and that has all access rights. After successful allocation, server 750 may transmit a confirmation of the allocation in block 4 of the operation flow. In this confirmation, server 750 may include information used to access the portion of storage space, such as a drive letter, a folder location, and the like.

In response, in block 5 of the operation flow, John's computing device 700 may execute mounting instructions 722 to mount the portion of storage space, such that John may access the space through interaction with computing device 700 in a manner similar to a local drive. Finally, in block 6 of the operation flow, displaying instructions 723 may display an icon 732 on output device 730, such that John may quickly access the portion of remote storage space by double-clicking or otherwise selecting icon 732.

FIG. 7B is a block diagram of an example operation flow for transferring exclusive access to remote storage space. As illustrated, in block 1 of the operation flow, John may indicate that he wishes to transfer exclusive access to the portion of remote storage space to Jane. Accordingly, sending instructions 724 may prepare and transmit a message to server 750, indicating that John wishes to transfer read access to Jane.

Receiving instructions 793 of server 750 may receive the message and trigger execution of modifying instructions 794. Then, in block 2 of the operation flow, modifying instructions 794 may modify entry 782 in storage records 780 to indicate that Jane is the current user with exclusive access and that she only has permission to read from the storage space. In block 3a, server 750 may transmit a confirmation to John, while, in block 3b, server 750 may transmit a notification to Jane's computing device 740 indicating that she has received read access to the portion of storage space.

In response to receipt of the notification, in block 4 of the operation flow, John's computing device 700 may modify the icon displayed on output device 730. In particular, displaying instructions 723 may modify icon 734 to indicate that John no longer has exclusive access to the portion of storage space. As illustrated, displaying instructions 723 have modified icon 734 to use dotted lines, thereby providing feedback to John that the drive cannot be accessed. In some embodiments, displaying instructions 723 may also provide an indication of the current user with exclusive access. Thus, in this example, displaying instructions 723 may display the text, “Jane,” or a picture of Jane near icon 734, such that John may quickly determine which user has exclusive access to the portion of storage space.

FIG. 7C is a block diagram of an example operation flow for accessing remote storage space. As illustrated, Jane currently has exclusive access to the portion of remote storage space. Accordingly, in block 1 of the operation flow, Jane may submit an access request to server 750. More specifically, accessing instructions 725 may transmit an access request to server 750.

Receiving instructions 793 in server 750 may receive the access request and trigger processing instructions 795 to handle the request. In particular, in block 2 of the operation flow, processing instructions 795 may query storage records 780 to determine whether Jane is the user currently granted exclusive access and, if so, whether the particular access request is within her rights. More specifically, because entry 782 indicates that Jane has read-only rights, any other requests (e.g., write, delete) will be denied. In block 3 of the operation flow, processing instructions 795 may access storage space 770 using the location specified in the access request and return any data. Finally, in block 4 of the operation flow, processing instructions 795 may transmit the requested data to Jane if the request is a read access and transmit an error if the request is any other type of access.

FIG. 7D is a block diagram of an example operation flow for regaining exclusive access to remote storage space. As illustrated, John may wish to regain exclusive access to the portion of remote storage space and may therefore submit a request or demand to his computing device 700. Then, in block 1 of the operation flow, sending instructions 724 may transmit the demand or request to regain exclusive access to server 750.

In block 2a of the operation flow, in response to receipt of a request by receiving instructions 793, server 750 may transmit a request to Jane indicating that John wishes to regain exclusive access. In block 2b, Jane's computing device 740 may reply with the response entered by Jane. In block 3 of the operation flow, when Jane has agreed to return access to John or the original message from John was a demand (rather than a request), modifying instructions 794 may modify entry 782 to indicate that John is the user with exclusive access. Modifying instructions 794 may also update the access rights to “All,” since John is the owner of the portion of storage space and therefore has all rights in accessing the data.

In block 4 of the operation flow, server 750 may transmit a response to John, indicating whether the request or demand to regain exclusive access was successful. In block 5, when the request or demand was successful, displaying instructions 723 may update the icon 732 on output device 730 to indicate that John again has exclusive access to the portion of storage space.

According to the foregoing, various embodiments provide remote storage to a user using a model that is easy to utilize and understand. In particular, a user may request allocation of a portion of storage space and, in some embodiments, specify the desired size of the portion. Upon successful allocation of this space, the user may, in some embodiments, access the storage space as if it were a local drive, such as a flash memory drive. Furthermore, the user may easily transfer exclusive access to another user in a manner similar to physically transferring possession of a portable storage device and, in some embodiments, may restrict the access rights of the other user. Similarly, a user may regain exclusive access by sending a request or demand to the server, in a manner similar to requesting return of a loaned drive. Ultimately, the embodiments described in detail herein provide a robust, user-friendly mechanism for obtaining and sharing remote storage space.

We claim:

1. A server for providing remote storage space to users, the server comprising:
a processor;
a storage area; and
a machine-readable storage medium encoded with instructions executable by the processor, the machine-readable storage medium comprising:
instructions for allocating a portion of storage space in the storage area in response to a request from a first remote user,
instructions for maintaining storage records, the storage records identifying a user currently granted exclusive access to the portion of storage space, and
instructions for processing access requests, the processing including determining whether a remote user requesting access to the portion of storage space is the user currently granted exclusive access.

2. The server of claim 1, wherein the storage records further identify the first remote user as an owner of the portion of storage space.

3. The server of claim 2, wherein:
the machine-readable storage medium further comprises instructions for receiving a request to transfer exclusive access from the owner of the portion of storage space to a second remote user; and
the instructions for maintaining the storage records comprise instructions for modifying the storage records to indicate that the second remote user is the user currently granted exclusive access to the portion of storage space.

4. The server of claim 3, wherein:
the machine-readable storage medium further comprises instructions for receiving, from the owner of the portion of storage space, an indication of access rights to be provided to the second remote user, and
the instructions for processing access requests enforce the access rights specified in the indication from the owner.

5. The server of claim 3, wherein the machine-readable storage medium further comprises:
instructions for sending a notification to the second remote user that the second remote user has been granted exclusive access to the portion of storage space.

6. The server of claim 3, wherein:
the machine-readable storage medium further comprises instructions for receiving a demand from the owner to regain exclusive access to the portion of storage space, and
the instructions for maintaining the storage records comprise instructions for modifying the storage records to indicate that the owner is the user currently granted exclusive access to the portion of storage space.

7. The server of claim 3, further comprising:
instructions for receiving a request from the owner to regain exclusive access to the portion of storage space, and
instructions for sending a request to the second remote user requesting that the second remote user grant permission to restore exclusive access to the owner.

8. The server of claim 1, wherein:
the request from the first remote user identifies a total amount of storage space desired,
the storage records further identify the total amount of storage space allocated, and
the instructions for processing access requests verify that an amount of space occupied for the portion of storage space does not exceed the total amount of storage space allocated.

9. A machine-readable storage medium encoded with instructions executable by a processor of a computing device, the machine-readable storage medium comprising:
instructions for requesting allocation of a portion of storage space by sending an allocation request of a first user to a remote server;
instructions for mounting a local drive corresponding to the portion of storage space upon receipt of confirmation of the allocation of the portion of storage space from the remote server; and
instructions for requesting transfer of exclusive access to the portion of storage space to a second user by sending a transfer request to the server.

10. The machine-readable storage medium of claim 9, further comprising:
instructions for displaying a first indication on a display of the computing device when the first user has exclusive access to the portion of storage space on the remote server; and
instructions for displaying a second indication different than the first indication when the first user has transferred exclusive access to the second user.

11. The machine-readable storage medium of claim 10, wherein the first indication is a first icon and the second indication is a second icon that is visually different than the first icon.

12. The machine-readable storage medium of claim 9, further comprising:
instructions for sending a demand from the first user to the remote server, the demand providing an instruction to restore exclusive access to the portion of storage space to the first user; and
instructions for sending a request from the first user to the remote server, the request providing an instruction to the remote server to request that the second user grant permission to restore exclusive access to the portion of storage space to the first user.

13. A method for providing remote storage space to users of a server comprising a storage area, the method comprising:
receiving, in the server, a request from a first remote user for allocation of a portion of storage space in the storage area;
recording, in storage records in the server, that the first remote user is allocated the portion of storage space and that the first remote user is currently granted exclusive access to the portion of storage space;
receiving a request from the first remote user to transfer exclusive access to the portion of storage space to a second remote user; and
recording, in the storage records, that the second remote user is currently granted exclusive access to the portion of storage space.

14. The method of claim 13, further comprising:
receiving, from the first remote user, an indication of access rights to be granted to the second remote user upon transferring exclusive access; and
recording the access rights to be granted to the second remote user in the storage records.

15. The method of claim 14, further comprising:
receiving an access request from a requesting user to access the portion of storage space in the storage area;
determining whether the requesting user is the user currently granted exclusive access to the portion of storage space; and
when the requesting user is the user currently granted exclusive access to the portion of storage space, determining whether the access identified in the access request complies with the access rights granted to the requesting user by the first remote user.
